(19) United States
(12) Patent Application Publication
(10) Pub. No.: US 2025/0036781 A1
(43) Pub. Date: Jan. 30, 2025

(54) METHOD FOR THE CRYPTOGRAPHY OF A PHRASE OF WORDS

(71) Applicant: CRYPTO KEY GUARDIAN, LASNE (BE)

(72) Inventors: Olivier Jean René LIBON, La Hulpe (BE); Hugues Georges Henri DORCHY, Ixelles (BE)

(73) Assignee: CRYPTO KEY GUARDIAN, LASNE (BE)

(21) Appl. No.: 18/767,670

(22) Filed: Jul. 9, 2024

(30) Foreign Application Priority Data
Jul. 25, 2023 (EP) 23075002.8

(51) Int. Cl. G06F 21/60; G06K 19/06

(52) U.S. Cl. CPC G06F 21/602; G06K 19/06037

(57) ABSTRACT

A method for the cryptography of a phrase of words comprising the generation of parts of the phrase, their coding in the form of barcodes, the production of these barcodes on physical and/or computing media, and the dissemination of these media to several locations. The invention also relates to a method for determining a phrase of words encrypted by means of the aforementioned cryptography method.

### CROSS-REFERENCE TO RELATED APPLICATION

This application claims priority to European Patent Application No. EP 23075002.8, filed Jul. 25, 2023, the entire disclosure of which is hereby expressly incorporated by reference herein for all purposes.

### TECHNICAL FIELD

The invention relates to a method for the cryptography of a phrase of words.

### TECHNICAL BACKGROUND

It has become common to practice using private keys to access digital data within a blockchain, for example data associated with a cryptocurrency account. The private keys are generally grouped together in a single password in the form of a phrase of words referred to as a “seed phrase”. This phrase can then be used to access the data, in particular as a private key and/or as a tool for recovering or restoring private keys.

This phrase must be kept in the strictest secrecy to prevent data theft (and cryptocurrencies where applicable). In fact, any third party with access to this phrase ultimately owns this data. It is therefore not advisable to entrust this phrase to a third party.

As this phrase typically comprises a large number of words, generally 24 words in the case of cryptocurrency applications, it is complex and highly risky to memorise it without any physical and/or computing medium (hardware, sheet of paper, etc.). In the event of forgetting, for example, following an accident or an illness, or in the event of death, the data may become permanently inaccessible.

If the phrase is produced on a non-computing physical medium, such as a writing on a sheet of paper or an engraving on a resistant material, there is a risk that the medium may be lost, damaged and/or destroyed. In addition, it may be easy for a third party to physically steal or copy (for example, by simply taking a photograph) the medium.

If the phrase (and generally the private keys) are accessible online on a third party server or centralised third party computing medium, the risk of loss and/or destruction is lower, but the risk of hacking is considerable. In addition, the access control to the data is no longer guaranteed because it depends on a computing medium and/or a method over which the owner of the data ultimately has no total control. This is particularly true when the access is done via an exchange, brokerage or data (or, where applicable, cryptocurrency) exchange platform, which may go bankrupt or restrict the data exchanges.

If the phrase (and in general the private keys) are accessible offline on a physical and computing medium over which the owner has a total control (for example, a USB key or a hard disk), the risks of loss, damage and/or destruction, and even technical failure, remain fairly high.

In addition to the technical difficulties of preserving a “seedphrase” as outlined above, there is also a more general need to manage this phrase in certain circumstances, for example, when the owner dies, which may make it impossible for the heirs to access the phrase due to a lack of information in this regard.

To date, there is no solution for conserving and/or managing and/or restoring a “seedphrase” that does not have the disadvantages described above.

### DISCLOSURE OF THE INVENTION

One object of the invention is to provide such a solution. In particular, one of the purposes of the invention is to provide a method for the cryptography of a phrase of words that allow to store it in a way that is controlled by its owner, secure and decentralised, avoiding the compulsory dependencies on a third party, and limiting the risks of loss, degradation, destruction and/or related failure.

To this end, the present invention proposes a method for the cryptography of a phrase of words implemented by computer and comprising the following steps:
(i) algorithmically generating a plurality of parts of the phrase such that the phrase can be determined from a minimum quantity of these parts;
(ii) coding each of the parts in the form of a barcode;
(iii) producing the barcodes on physical and/or computing media;
(iv) storing the media in several locations, so that the barcode or the barcodes produced on the medium or the media stored in each of the locations are, in number, strictly less than the minimum quantity.

The method described in the invention allows to cryptography a phrase of words so that it can be stored securely. The cryptography is effective because it involves steps (i) and (ii) corresponding to an advantageous combination of two cryptographic techniques.

The storage and the management of the phrase according to the method of the invention is decentralised, as it takes place in several distinct locations. As no single location contains enough barcodes (and therefore information) to determine the phrase, no third party can determine the phrase from a single location.

The owner of the phase typically exercises an exclusive and sole control (“self-custody”) over the access to the phrase, as he stores the media in locations that he chooses. By using several parts of the phrase, it allows to limit the risk of loss, damage and/or destruction. On the one hand, it seems unlikely that a large number of media stored in different locations would be lost, damaged, destroyed or fail at the same time. On the other hand, given that a minimum quantity of these parts is sufficient to determine the phrase, even if one of these media is lost, damaged, destroyed or fails, it should still be possible to determine the phrase from the other media.

The use of barcodes in step (ii) is advantageous. The barcodes are a well-known coding method, for which there are numerous readers freely available on the market. This makes them accessible and easy to use. Moreover, the barcodes are sufficiently widespread that the presence of a barcode on a physical medium when it is visible does not arouse the covetousness of a third party, unlike a list of 24 words very easily recognisable as an access code to a cryptocurrency account. The barcodes also prevent for a third party to determine a coded information directly (“by eye”). Finally, the barcodes are easy and compact to produce, store and, above all, distribute to multiple locations, making them a coding of choice for the method described in this invention.

Steps (i) to (iv) are logically executed in this order, although steps (iii) and (iv) can be executed simultaneously. Steps (i), (ii) and (iv) can be reversed and executed in reverse order to restore the phrase as described below.

By the terms “method implemented by computer”, the method of the invention involves the use of a computer, a computing network and/or another programmable (for example, a smartphone, a tablet, an FPGA, etc.) or programmed (for example, an integrated circuit/ASIC, etc.) apparatus and is such that one or more of its steps or characteristics are carried out wholly or in part by a computer program. In particular, said term “computer” is not to be interpreted restrictively as limiting the implementation of the method to the sole use of a physical computer. The invention can be implemented by various digital processing means such as a computer, a smartphone, a computing network, a distributed computing system and/or a server, this list being non-limitative.

The method is therefore at least partly of an underlying computing nature. For example, steps (i) and (ii) are typically an algorithmic determination. Preferably, these steps are implemented entirely by computer, while step (iii) can be implemented both by computer (for example, by recording the barcodes on computing media readable by computers) and without a computer (for example, by a manual or photographic reproduction of the barcodes), or by mixed means (for example, by means of a computer connected to a printer for printing the barcodes on paper). Step (iv) can also be implemented by computer (for example, in the case of the recording of the barcodes on remote servers which ultimately results in the storage of the media in separate locations—those of the remote servers) or without a computer (for example, in the case of physical media which are simply physically placed in said locations, this embodiment being preferred).

The use of an offline computer (i.e. not connected to a computing network) is preferred in order to limit the risks of hacking and dependence on a third party (third-party server, etc.). In which case, the computer is provided with an executable program in order to implement off-line the appropriate steps of the method according to the invention, at least steps (i) and (ii), and/or their inversion as presented in the form of steps (b) and (c) introduced below.

The method according to the invention can be applied to any phrase of words, beyond the context set out in the prior art. However, the use of the method when the phrase consists of a key for accessing digital data (encrypted) stored in a blockchain is preferred, particularly if that data is associated with a cryptocurrency account. In this case, the phrase is preferably a “seed phrase”.

Preferably, there are at least 4 parts of the phrase generated in step (i), preferably at least 6. Step (i) is all the more advantageous in terms of decentralisation and preservation against the loss, the degradation and/or the destruction if a sufficient number of parts are generated. Step (i) can be implemented by any appropriate algorithmic technique known to the person skilled in the art, for example, by a distributed secrecy, or more precisely by a Shamir secret key sharing.

It follows from the description of the method according to the invention that the minimum quantity is typically greater than or equal to 2. This underpins the preferred principle of non-collusion of the information contained in the parts, which allows to avoid or limit the risk of the phrase being determined in an undesired way by its owner. For example, the minimum quantity is at least a third of the number of parts, or at least half the number of parts. In this way, it is necessary to have enough parts of the phrase to determine the phrase, which makes the method more secure and decentralised.

The minimum quantity is preferably strictly less than the number of parts. This underpins the preferred principle of redundancy of information contained in the parts. In this way, it is not necessary to possess all the parts to determine the phrase, and the loss, damage, destruction or failure of one part does not prevent the phrase from being determined. For example, the minimum quantity is at most two-thirds of the number of parts, which gives greater freedom to determine the phrase, while remaining restrictive.

Such practical examples of pairs formed of the number of parts, denoted N, and the minimum quantity are (N, ┌N/3┐), (N, └N/2┘), (N, ┌N/2┐), (N, └2N/3┘) where └-┘ and ┌-┐ designate the “lower integer part” and “upper integer part” operators respectively, for N=4, 5, 6, 7, 8, 9, 10, 11 or 12, these examples being non-limiting.

Step (ii) can be implemented using appropriate techniques known to the person skilled in the art for mapping an alphanumeric chain into a barcode. The barcodes can be single or multi-dimensional. In particular, they are preferably two-dimensional and preferably consist of QR codes.

The matrix form of the QR codes allows to record a large amount of information. Moreover, the QR codes are widely known to the general public and can be easily read by any electronic device equipped with a dedicated application, without the need for complex and specific decoding software or a connection to a particular computing network.

However, the method can be applied in an equivalent way with other systems for symbolic representation of alphanumeric chains.

In the context of this document, a physical medium may comprise a sheet of paper on which a barcode is written, an object on which a barcode is engraved or written, a computer-readable computing medium such as a USB key on which a barcode is recorded, etc. These examples are not limitative. In the context of this document, a computing medium is preferably computer-readable and consists of at least one information storage medium in digital form. It comprises, for example, at least one of the following: a digital memory, a server, a USB key or a computer. It can be in a cloud.

The term “produce” in step (iii) therefore has a generic meaning covering, in the above examples, but not limited to, the writing, the engraving, the digital recording, and so on.

Step (iv) can be implemented in various ways, and in some cases follows step (iii). For example, when a barcode is recorded (and therefore produced) on a data cloud, it is necessarily associated with a server hosting the corresponding data in the data cloud. In this case, the location is that of the server. When a barcode is recorded on the hard drive of a smartphone belonging to the owner of the phrase, the location is defined by the location of the smartphone. When different computing media are used, they are preferably not connected to each other, and in particular not connected in such a way that data can be exchanged.

The term “location” preferably refers to the physical position of a medium. Preferably, the media are physical, physically accessible to the phrase owner, and are specifically and physically placed in step (iv) at a distance from each other, in their respective locations. These are preferably spaced at least one metre apart. They can, for example, be defined by rooms in the dwelling of the owner of the phrase. The locations are preferably within a radius of no more than 100 km, and more preferably no more than 20 km around a point in space.

The locations can also be different dwellings of third parties or locations known to third parties to whom the owner of the phrase has given a medium. In this way, each third party does not have enough information about the medium or media it owns to determine the phrase, which can be determined if a certain number of third parties (and possibly the owner) come together to own at least the minimum number of parts.

In such a case, preferably, the barcodes produced on the media supplied to the third parties are, in number, at most equal to the minimum quantity, so that, either the third parties are not able to determine the phrase even by grouping together, or all the third parties must be brought together to determine the phrase. For example, if the number of parts is 6 and the minimum quantity is 3, the owner of the phrase can entrust a medium comprising a single barcode to each of three third parties, and store three other media each comprising a single barcode in three locations known only to him. In this way, it retains a total control over the phrase access. Such a configuration can also be useful in the event of the owner's death, as it allows the third parties to determine the phrase if they are invited to do so (via a will, for example).

The use in this document of the verb “comprise”, its variants or conjugations, does not exclude the presence of elements other than those mentioned. Similarly, the use of the indefinite article “a”, “an”, or the definite article “the” to introduce an element does not exclude the presence of a plurality of these elements.

In one embodiment of the method, each barcode is produced only once in step (iii). In this way, the risks of theft are limited, as are the risks of confusion between the identical or different parts, without increasing the risks in terms of loss of access to the phrase through loss, destruction or damage to the media if the minimum quantity is sufficiently smaller than the number of parts.

In another embodiment of the method, at least one of the barcodes is produced on a plurality of separate media, each of these media being stored in one of the separate locations. This embodiment allows to increase the number of possibilities for distributing the media between the locations, while further reducing the risk of losing access to the phrase through loss, destruction or degradation of the media, as several media provide access to the same part of the phrase. In this embodiment, the information corresponding to the parts of the phrase is redundant.

In one embodiment of the method, each of the media comprises one (and only one) of the barcodes. In one embodiment of the method, each of the locations comprises one (and only one) of the media. These two embodiments allow the access to the parts of the phrase to be distributed to different locations in a controlled and uniform way.

The method applies to any phrase of at least two words.

The phrase of words is generally represented numerically by bits. The method preferably comprises the following step preceding step (i) if the number of bits in the phrase is strictly smaller than a fixed threshold: completing the phrase with one or more additional words so that it is represented by at least this bit threshold.

This additional step allows to operate with a phrase that has sufficient entropy and is therefore more difficult to hack, steal or reproduce. It is typically implemented by the phrase owner, for example following a request from an electronic interface of a computer before step (i) is executed. Preferably, the phrase comprises 12, 18 or 24 words, and each is represented by the same number of bits, for example 11 bits (corresponding to 2048 choices per word). More preferably, the phrase is normalized in BIP39 format and/or the above-mentioned additional step corresponds to a normalization of the phrase in this format. Preferably, said threshold is at least 132 bits, more preferably 264 bits (corresponding to 24 words of 11 bits, with an entropy of 256 bits and a checksum of 8 bits).

Preferably, each of the parts of the phrase has one or more of the aforementioned technical characteristics relating to the phrase. Preferably, the parts are also standardised in BIP39 format.

According to a variant, the method also comprises the following step prior to step (i): time-stamping the phrase. The time-stamping allows the owner of the phrase to avoid any duplication or confusion in the execution of the method. In particular, this can happen if it modifies or corrects the phrase and then swaps the original phrase and the modified or corrected phrase, or if it encrypts several different phrases in a short space of time.

According to a variant, the method also comprises the following step between steps (i) and (ii): time-stamping each of the parts of the phrase. This has similar advantages to the time-stamping of the phrase, and in particular allows to avoid mixing parts of different phrases in the execution of the method.

In both of the above variants, the time-stamping is preferably performed to the nearest millisecond.

According to a variant, the method also comprises the following step between steps (i) and (ii): encrypting each of the parts of the phrase, which are preferably time-stamped beforehand if necessary. The encryption is preferably implemented by means of a symmetrical encryption key. It preferably consists of an AES encryption, and the encryption key preferably comprises at least 256 bits. Advantageously, in the latter case, the encryption is quantum safe.

Such an encryption increases the security of the method, as the latter combines three different cryptographic techniques. It allows the owner of the phrase to retain a total control over the method if he alone is in possession of the (de)encryption key. So even if third parties collect media in such a way that the barcodes produced on these media are, in number, at least the minimum quantity, they cannot in any case determine the phrase without this (de)encryption key.

The (de)encryption key can be generated and/or stored by means of a computing module for added security. For example, it can be provided that the computing module delivers the (de)encryption key on the basis of an identification of the owner of the phrase, typically via a technique for identifying and/or strongly authenticating the owner (for example, by reading an electronic identity card or a similar document). The computing module can be an integral part of a third-party computing system.

The aforementioned time-stamping or time-stampings and/or the encryption are preferably implemented entirely by computer.

According to one embodiment of the invention, the method further comprises, after step (iv), the following step:
(v) storing on a third party computing medium information about at least one of the locations and/or of the media, contact data of a third person, and at least one condition under which that information can be transferred to that third person by means of the contact data.

Preferably, it also comprises, after step (v), the following step:
(vi) transferring said information to the third person when the condition is met.

This embodiment is advantageous because it provides the subsequent management of the encrypted phrase by the method. For example, thanks to steps (v) and (vi) the owner of the phrase can plan to communicate to his heirs (the third person or persons in this case) the locations or the holders of the media (the information in this case) so that they can determine the phrase in the event of the owner's death (the condition in this case), but not before.

This embodiment is not limited to the case of the owner's heritage, but can concern any other condition, for example a medical condition of the owner of the phrase, or generally any type of triggering event. A relatively long period of time may elapse between an execution of step (v) and an execution of step (vi), particularly in view of the nature of the condition. Similarly, step (v) can be executed a long time after step (iv).

The third-party computing medium is preferably the one comprising the computing module for generating and/or storing the (de)encryption key for the corresponding embodiments of the invention. In this case, it may be plan that for the (de)encryption key to be delivered to the third person along with the aforementioned information. This allows the third person to determine the phrase if that is the purpose of the information.

Step (vi) is optionally executed subject to an identification of the third person (for example, by reading his identity card) with a third party computing system to which the third party computing medium belongs.

Step (vi) is preferably executed on the basis of a transfer prior to the computing system of a proof that the condition is satisfied. This transfer can be done actively, by the third person for example, but can also be performed automatically and/or algorithmically if the third party computing system is configured to access condition data online, or even to automatically and/or algorithmically execute step (vi). This is for example the case if the third party computing system is distributed and/or is in the form of a blockchain configured to access, preferably online, data relating to the condition and to algorithmically execute step (vi), for example by executing smart contracts programmed into the blockchain. The terms of the contract can then implement the condition if it is of such a nature as to allow this (for example, a death, a date, a notable public event, etc.) and the transfer of information algorithmically without any intermediate human intervention. Steps (v) and (vi) are then typically executed on-line, without however preventing the other steps (i) to (iv) of the method from being executed off-line. These preferred embodiments do not exclude from the scope of the invention the case where steps (v) and/or (vi) are carried out off-line.

The invention also proposes a method for determining a phrase of words encrypted by means of the method according to the invention, the determination method being implemented by computer and comprising the following steps:
(a) collecting media on which barcodes encoding at least the minimum quantity of parts are produced;
(b) reading the barcodes produced on the media collected in step (a) so as to decode them in the form of parts of the phrase;
(c) determining the phrase from the parts resulting from the reading in step (b).

This determination method allows the cryptographic method described in the invention to be reversed, so that the advantages of the latter are transposed mutatis mutandis to the former. Steps (b) and (c) are preferably fully implemented by computer, whereas step (a) may or may not be implemented by computer in the same way as step (iv).

The determination method according to the invention is typically implemented following the cryptography method according to the invention, so that steps (a) to (c) can be considered equivalently as optional steps to the cryptography method which follow steps (i) to (iv).

In the case of the embodiment in which the parts of the phrase decoded in step (b) are also encrypted, step (c) comprises a sub-step for decrypting the encrypted parts.

The reading of the barcodes in step (b) are typically read by scanning, for example, or photographic reading. It's easy to read. This can be done using an electronic device suitable for this purpose and known to a person skilled in the art, for example a smartphone which can be equipped with a suitable digital application. Typically, such an electronic device comprises a camera or an optical reader for reading the barcode.

The present invention also proposes:
a data processing computing system comprising means configured to implement the cryptography and/or determination method according to the invention;
a computer program comprising instructions which, when the computer program is executed by a computer, cause the computer program to implement the cryptography and/or determination method according to the invention;
a computer-readable computing medium on which the above-mentioned computer programme is recorded.

The steps of the respective methods implemented via the computing system and the computer program comprise at least steps (i) and (ii), and/or (b) and (c).

The computer program is preferably designed to be executed offline, without any third-party dependencies. The computing medium on which it is recorded can thus be supplied to the owner of a phrase of words so that he can execute the programme on a computer disconnected from any computing network. The risk of hacking is thus limited and the owner has greater certainty about the integrity of the programme (for example, he cannot foresee a copy of the key being sent to a third-party server without the owner's knowledge).

The computing system comprises, for example, a hardware or a computing equipment from:
a computer equipped with a processor for executing algorithms, preferably with a PC-type architecture or an embedded architecture (ARM);
an ASIC integrated circuit specific to an application and/or an algorithm;
an FPGA-type (logic) integrated circuit, which is typically reconfigurable or reprogrammable after manufacture.

This hardware or computing equipment allows at least steps (i), (ii), (b) and (c) of the above methods to be implemented, and optionally steps (iii), (iv) and (a) of these methods. The computing system may further comprise other computing equipment such as a printer or a machining tool connected to a computer as aforesaid to receive instructions to produce the barcodes on the media in step (iii).

The embodiments and the advantages of the methods according to the invention apply mutatis mutandis to the data processing computing system, the computer program and the computer readable computing medium according to the invention.

The disclosed subject matter is further introduced in the claims. As it will be understood by a skilled person from the present disclosure, any one of the embodiments presented in these claims can be considered alone or in combination. In particular, the dependency of the claims can be considered in a broader manner so that any one of the possible combinations of the claims—as far as they are technically possible and understood by the person skilled in the art, in particular in view of the present disclosure—are part of the present application.

### BRIEF DESCRIPTION OF THE FIGURES

Other characteristics and advantages of the present invention will become apparent from the following description, reference to which is made in

FIG. 1, which shows a flowchart of the method according to one embodiment of the invention.

The drawings in the FIGURE are not to scale. The identical and/or similar elements may bear the same and/or similar references. The presence of reference numbers or letters in the drawings is not restrictive, even when these numbers or letters are indicated in the claims.

### DESCRIPTION OF AN EMBODIMENT OF THE INVENTION

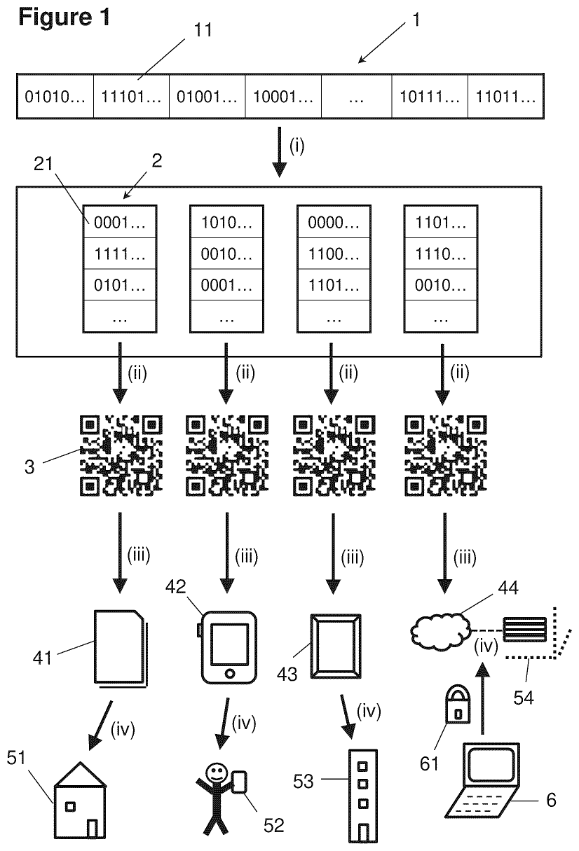

A description of one embodiment of the invention is given below with reference to FIG. 1. It is schematic and does not limit the invention.

FIG. 1 shows an execution of an embodiment of the method for the cryptography of a phrase 1 of words 11 according to the invention. The phrase 1 is in the form of 24 words of 11 bits and can be normalized in BIP39 format so that it has an entropy of 256 bits. One example is a private “seed phrase” for recovering private keys giving access to digital data stored in a blockchain and associated with a cryptocurrency account.

In step (i), a Shamir secret key sharing algorithm is executed on the basis of the phrase 1 so as to divide it into several distinct parts 2, for example at least four parts, although not all these parts 2 are necessary to reconstitute the phrase 1. A minimum quantity of these parts 2, for example between 40 and 60%, is sufficient to algorithmically determine the phrase 1 using the algorithmic techniques known to the person skilled in the art. A single part 2 is not sufficient for this purpose. The minimum quantity is, for example, 2 if the number of parts 2 is 4.

Each of the parts 2 of the phrase 1 also comprises several words 21 represented in the form of bits. The words 21 can be represented by the same number of bits and the parts 2 can comprise the same number of words 21 so as to make the method more uniform. The parts 2 can also be standardised in BIP39 format. They can be time-stamped and/or encrypted as described in the description of the invention.

In step (ii), each of the parts 2 (which may previously have been time-stamped and/or encrypted) is encoded in the form of a barcode 3, more specifically a QR code, so that each barcode 3 uniquely corresponds to one of the parts 2 of the phrase 1. The barcodes 3 are then produced in a single exemplary in step (iii) on separate physical and/or computing media 41-44, preferably of different nature, which makes it all the more difficult for a third party to determine the phrase. FIG. 1 illustrates examples of such media 41-44:
a first barcode 3 is printed on a sheet of paper 41,
a second barcode 3 is recorded in digital format on the memory 42 of a smartphone belonging to the owner of the phrase 1,
a third barcode 3 is engraved on the frame 43 of a painting, and
a fourth barcode 3 is stored in a data cloud 44.

Finally, in step (iv), each of these media 41-44 is stored separately in a location 51-54 distinct from the others. As the barcode 3 on only one of the media 41-44 is not sufficient to determine the phrase, a third party randomly discovering one of the locations 51-54 will not be able to determine the phrase 1. Similarly, the loss, destruction, damage or failure of one of the media 41-44 (and/or one of the locations 51-54) does not prevent the phrase 1 from being determined from the other media 41-44, as not all parts 2 are required for this purpose. FIG. 1 illustrates examples of such locations 51-54:
the sheet of paper 41 is stored, for example, in a safe in a house 51 belonging to the owner of the phrase 1;
the memory 42 of the smartphone of the owner of the phrase 1 is a fortiori stored with the smartphone, in the location 52 in which it is located, for example, with the owner of the phrase 1;
the panel comprising the frame 43 serving as medium for the third barcode 3 is stored, for example, in a flat 53 belonging to a third party, for example a member of the family of the owner of the phrase 1;
the data cloud 44 is a fortiori stored with a remote third-party server with which it is associated, in the location 54 of this server, for example in a server room.

As can be seen from location examples 52 and 54, the step of the storage of the media can follow directly from the computing nature of these media. However, a computing medium may be physically stored in step (iv). For example, a USB key on which one of the barcodes 3 is recorded may be specifically stored in a safe or with a third party.

In the case of a data cloud 44 as a medium, as this is necessarily accessible via a network, in order to limit the access to the barcode 3 by any third party computer 6 and to reduce the risks of hacking the barcode 3, provision may be made to encrypt the data of the barcode 3 so that it can only be accessed by a decryption key 61.

In brief, the invention relates to a method for the cryptography of a phrase 1 of words 11 comprising generating parts 2 of the phrase 1, encoding these in a barcode 3 form, producing these barcodes 3 on physical and/or computing media 41-44, and disseminating these media 41-44 to a plurality of locations 51-54. The invention also relates to a method for determining a phrase 1 of words 11 encrypted by means of the aforementioned cryptography method.

The present invention has been described above in relation to specific embodiments, which are purely illustrative and should not be regarded as limiting. It will be readily apparent to the person skilled in the art that the invention is not limited to the examples illustrated or described above, and that its scope is more broadly defined by the claims hereinafter introduced.

1. A method for the cryptography of a phrase of words implemented by computer and comprising the following steps:
(i) algorithmically generating a plurality of parts of the phrase such that the phrase can be determined from a minimum quantity of these parts;
(ii) coding each of the parts in the form of a barcode;
(iii) producing the barcodes on physical and/or computing media;
(iv) storing the media in several locations, so that the barcode or the barcodes produced on the medium or the media stored in each of the locations are, in number, strictly less than the minimum quantity.

2. The method according to claim 1, wherein each barcode is produced only once in step (iii).

3. The method according to claim 1, wherein at least one of the barcodes is produced on a plurality of separate media, each of these media being stored in one of the locations.

4. The method according to claim 1, wherein each of the media comprises one and only one of the barcodes and each of the locations comprises one and only one of the media.

5. The method according to claim 1, wherein the phrase is represented by a number of bits, and wherein the method further comprises the following step preceding step (i) if the number of bits is strictly smaller than a fixed threshold: completing the phrase with one or more additional words so that it is represented by at least this bit threshold.

6. The method according to claim 1, wherein the minimum quantity is strictly less than the number of parts.

7. The method according to claim 1, wherein the barcodes are QR codes.

8. The method according to claim 1, further comprising the following step preceding step (i): time-stamping the phrase.

9. The method according to claim 1, further comprising the following step between steps (i) and (ii): time-stamping and/or encrypting each of the parts.

10. The method according to claim 9, wherein each of the parts is encrypted by means of a symmetrical encryption key generated and/or stored by means of a computing module.

11. The method according to claim 1, further comprising the following steps after step:
(v) storing on a third party computing medium information about at least one of the locations and/or of the media, contact data of a third person, and at least one condition under which that information can be transferred to that third person by means of the contact data;
(vi) transferring the information to the third person when the condition is met.

12. The method according to claim 11, wherein the third party computing medium belongs to a distributed third party computing system in the form of a blockchain and configured both to access online data relating to the condition and to execute step (vi) algorithmically, and
wherein step (vi) is executed by said distributed third party computing system.

13. A method for determining a phrase of words encrypted by means of the cryptography method according to claim 1, the determination method being implemented by computer and comprising the following steps:
(a) collecting media on which barcodes encoding at least the minimum quantity of parts are produced;
(b) reading the barcodes produced on the media collected in step (a) so as to decode them in the form of parts of the phrase;
(c) determining the phrase from the parts resulting from the reading in step (b).

14. The method according to claim 1, implemented by an off-line computer.

15. The method according to claim 1, wherein the phrase consists of a key for accessing digital data stored in a blockchain.

16. A data processing computing system comprising means configured to implement the method according to claim 1.

17. A non-transitory computer-readable computing medium on which is recorded a computer program comprising instructions which, when the computer program is executed by a computer, cause the computer program to implement the method according to claim 1.

18. The method according to claim 13 implemented by an off-line computer.

19. A data processing computing system comprising means configured to implement the method according to claim 13.

20. A non-transitory computer-readable computing medium on which is recorded a computer program comprising instructions which, when the computer program is executed by a computer, cause the computer program to implement the method according to claim 13.
